(19) United States
(12) Patent Application Publication
(10) Pub. No.: US 2024/0047127 A1
(43) Pub. Date: Feb. 8, 2024

(54) COIL COMPONENT AND METHOD OF MANUFACTURING COIL COMPONENT

(71) Applicant: Murata Manufacturing Co., Ltd., Kyoto-fu (JP)

(72) Inventors: Yuki KANBE, Nagaokakyo-shi (JP); Yukinobu MASUDA, Nagaokakyo-shi (JP); Tetsuya TANIMOTO, Nagaokakyo-shi (JP); Hayato TAKAHASHI, Nagaokakyo-shi (JP); Ryota HASHIMOTO, Nagaokakyo-shi (JP)

(73) Assignee: Murata Manufacturing Co., Ltd., Kyoto-fu (JP)

(21) Appl. No.: 18/362,620

(22) Filed: Jul. 31, 2023

(30) Foreign Application Priority Data
Aug. 2, 2022 (JP) 2022-123526

(51) Int. Cl. H01F 27/30; H01F 27/24; H01F 41/06

(52) U.S. Cl. CPC H01F 27/306; H01F 27/24; H01F 41/06

(57) ABSTRACT

A coil component includes a drum core, a first wire, and a second wire. The drum core includes a winding core, a first flange, and a second flange. The first wire includes a first winding portion. The second wire includes a second winding portion. When the second wire is traced from the end at the first flange toward the second flange, a specific position is a position at which the second wire comes into first contact with an outward-facing part of the first wire, and a specific turn is a turn of the second wire that is wound around from the specific position so as to proceed toward the second flange. The second winding portion has, within the specific turn, two intersections at which the second wire intersects the first wire.

### CROSS-REFERENCE TO RELATED APPLICATION

This application claims benefit of priority to Japanese Patent Application No. 2022-123526, filed Aug. 2, 2022, the entire content of which is incorporated herein by reference.

### BACKGROUND

### Technical Field

The present disclosure relates to a coil component and to a method of manufacturing the coil component.

### Background Art

A coil component described in Japanese Unexamined Patent Application Publication No. 2020-126976 includes a winding core and two flanges. The winding core is shaped like a quadrangular prism. Two flanges are connected to opposite ends of the winding core. Each flange projects outward from the winding core in directions orthogonal to the central axis of the winding core. The winding core and the flanges are made of a magnetic substance. The winding core and the flanges form a core of the coil component.

The coil component further includes four outer electrodes, a first wire, and a second wire. The first wire is wound around the winding core. The part of the first wire that is wound around the winding core is in contact with the peripheral surfaces of the winding core. Adjacent turns of the first wire are in contact with each other.

A major part of the second wire is wound around the winding core. The winding direction of the second wire is the same as that of the first wire. The part of the second wire that is wound around the winding core is positioned on an outward-facing part of the first wire. Turns of the second wire are fitted in respective grooves formed by adjacent turns of the first wire.

When the second wire is wound around the winding core of the coil component described in Japanese Unexamined Patent Application Publication No. 2020-126976, the second wire is pressed against the first wire. Due to the pressing force, the second wire, which is supposed to stay on the outward-facing part of the first wire, may fall in between adjacent turns of the first wire. As a result of each wire being wound differently from the design specification, the coil component is not likely to provide the characteristics as designed.

### SUMMARY

According to an aspect of the present disclosure, a coil component includes a drum core. The drum core has a winding core shaped like a column or prism, a first flange connected to a first end portion of the winding core, the first end portion being positioned along a central axis of the winding core, and a second flange connected to a second end portion of the winding core, the second end portion being positioned oppositely to the first end portion along the central axis. The coil components also includes a first wire wound around the winding core and a second wire wound around the winding core. The first wire includes a first winding portion wound around with the central axis being a center of winding. The second wire includes a second winding portion wound around with the central axis being the center of winding. When i) a specific position is a position at which the second wire comes into first contact with an outward-facing part of the first wire, the part facing oppositely to the winding core, when the second wire is traced from an end thereof at the first flange toward the second flange and ii) a specific turn is a turn of the second wire that is wound around from the specific position so as to proceed toward the second flange, the second winding portion has two intersections at which the second wire intersects the first wire within the specific turn.

According to another aspect of the present disclosure, a method of manufacturing a coil component includes a first step of winding a first wire around a drum core. The drum core includes a winding core shaped like a column or prism, a first flange connected to a first end portion of the winding core, the first end portion being positioned along a central axis of the winding core, and a second flange connected to a second end portion of the winding core, the second end portion being positioned oppositely to the first end portion along the central axis. The method of manufacturing the coil component also includes a second step of winding a second wire around the drum core. In the first step, a first winding portion is formed by winding the first wire around the winding core from the first flange with the central axis being a center of winding. In the second step, a second winding portion is formed by winding the second wire around the winding core from the first flange with the central axis being the center of winding. When i) a specific position is a position at which the second wire comes into first contact with an outward-facing part of the first wire, the part facing oppositely to the winding core, when the second wire is traced from an end thereof at the first flange toward the second flange and ii) a specific turn is a turn of the second wire that is wound around from the specific position so as to proceed toward the second flange, the second wire is wound, in the second step, in such a manner that the second wire intersects the first wire twice within the specific turn.

According to the above configuration, a portion of the specific turn of the second wire between the two intersections is brought into contact with the first wire from the side near the first flange and the other portion of the specific turn is brought into contact with the first wire from the other side near the second flange. Accordingly, a portion of the first wire being in contact with the specific turn of the second wire is pressed by the second wire from both sides along the central axis. As a result, the portion of the first wire being in contact with the specific turn of the second wire does not move easily along the central axis due to the pressing forces of the specific turn of the second wire. Since the portion of the first wire being in contact with the specific turn of the second wire does not move easily, the other portion of the first wire does not move easily. This increases the likelihood of each wire being wound around as planned.

The coil component can reduce the likelihood of disorderly winding.

### BRIEF DESCRIPTION OF THE DRAWINGS

FIG. 1 is a perspective view illustrating a coil component;

FIG. 2 is a plan view illustrating the coil component when the coil component is viewed in a third negative direction;

FIG. 3 is a side view illustrating the coil component when the coil component is viewed in a second negative direction;

FIG. 4 is a plan view illustrating the coil component when the coil component is viewed in a third positive direction;

FIG. 5 is a side view illustrating the coil component when the coil component is viewed in a second positive direction;

FIG. 6 is a partial cross-sectional view illustrating a coil component of a comparative example;

FIG. 7 is another partial cross-sectional view illustrating the coil component of the comparative example; and

FIG. 8 is a partial cross-sectional view illustrating the coil component.

### DETAILED DESCRIPTION

An embodiment of a coil component will be described. Note that elements in the drawings may be illustrated in an exaggerated manner to facilitate better understanding. Dimensional relations of elements in the drawings may be different from those of actual elements or may be different in different drawings.

Overall Structure

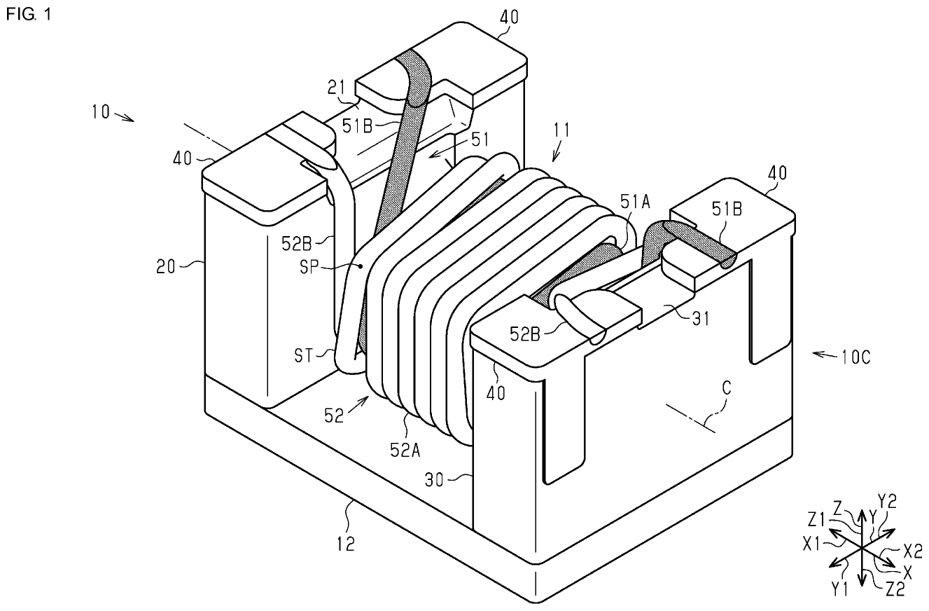

As illustrated in FIG. 1, a coil component 10 includes a drum core 10C and a top plate 12.

The drum core 10C includes a winding core 11, a first flange 20, and a second flange 30.

The winding core 11 is shaped like a quadrangular prism. A cross section of the winding core 11 that orthogonally intersects the central axis C of the winding core 11 is shaped like a rectangle. Note that the term “rectangle” as used herein may be a polygon having four sides and be shaped substantially like a rectangle, including a rectangle with a corner or corners being rounded. The winding core 11 is made of a non-conductive material. More specifically, the winding core 11 is made of, for example, alumina, Ni—Zn based ferrite, resin, or a mixture thereof.

A first axis X is defined as an axis that extends parallel to the central axis C of the winding core 11. A second axis Y is defined as an axis that orthogonally intersects the first axis X. In the present embodiment, the second axis Y extends parallel to two of the four sides of the winding core 11 when the winding core 11 is viewed along the first axis X. In addition, a third axis Z is defined as an axis that orthogonally intersects the first axis X and the second axis Y. In the present embodiment, the third axis Z extends parallel to the other two of the four sides of the winding core 11 when the winding core 11 is viewed along the first axis X. A first positive direction X1 is defined as a direction directed toward one side along the first axis X, and a first negative direction X2 is defined as the direction directed oppositely to the first positive direction X1. Similarly, a second positive direction Y1 is defined as a direction directed toward one side along the second axis Y, and a second negative direction Y2 is defined as the direction directed oppositely to the second positive direction Y1. In addition, a third positive direction Z1 is defined as a direction directed toward one side along the third axis Z, and a third negative direction Z2 is defined as the direction directed oppositely to the third positive direction Z1.

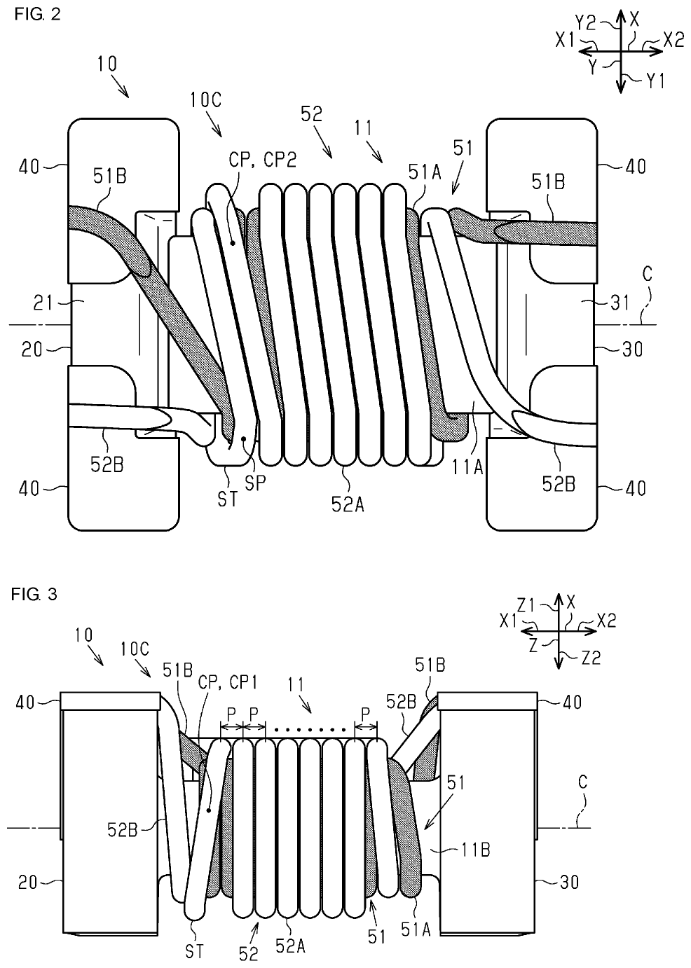

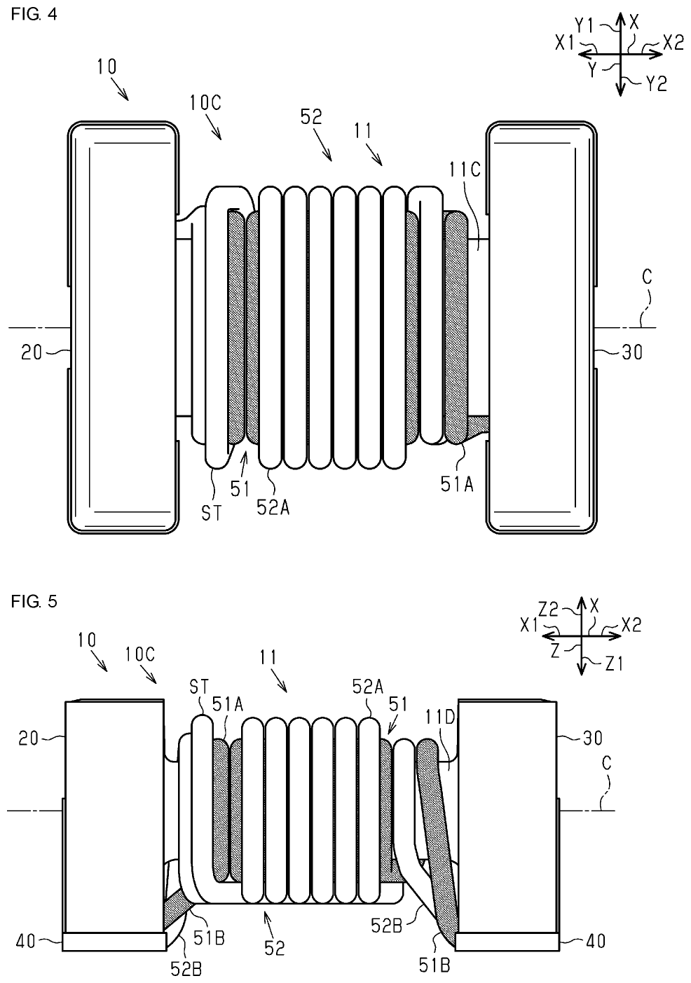

As illustrated in FIGS. 2 to 5, the winding core 11 has a first peripheral surface 11A, a second peripheral surface 11B, a third peripheral surface 11C, and a fourth peripheral surface 11D. In the present embodiment, the first peripheral surface 11A faces in the third positive direction Z1. The second peripheral surface 11B adjoins the first peripheral surface 11A. The second peripheral surface 11B faces in the second positive direction Y1. The third peripheral surface 11C adjoins the second peripheral surface 11B and extends parallel to the first peripheral surface 11A. Accordingly, the third peripheral surface 11C faces in the third negative direction Z2. The fourth peripheral surface 11D adjoins the third peripheral surface 11C and the first peripheral surface 11A and extends parallel to the second peripheral surface 11B. Accordingly, the fourth peripheral surface 11D faces in the second negative direction Y2. Note that the top plate 12 is not illustrated in FIGS. 2 to 5.

As illustrated in FIG. 1, the first flange 20 is connected to a first end portion of the winding core 11, the first end portion facing in the first positive direction X1. The first flange 20 projects outward from the winding core 11 in directions along the second axis Y and the third axis Z.

The first flange 20 has a recess 21. The recess 21 is recessed from an end surface of the first flange 20, the end surface facing in the third positive direction Z1. The recess 21 opens at opposite sides of the first flange 20, the sides facing in directions along the first axis X. Accordingly, the end surface of the first flange 20 facing in the third positive direction Z1 are divided into two portions with the recess 21 interposed therebetween. Note that the shape of the first flange 20 along the second axis Y is symmetrical.

The second flange 30 is connected to a second end portion of the winding core 11, the second end portion facing in the first negative direction X2. The material of the first flange 20 and the second flange 30 is the same non-conductive material as that of the winding core 11. The first flange 20 and the second flange 30 are formed integrally with the winding core 11.

The shape of the second flange 30 along the first axis X and the shape of the first flange 20 along the first axis X are symmetrical to each other. The second flange 30 projects outward from the winding core 11 in directions along the second axis Y and the third axis Z. The second flange 30 has a recess 31.

In the present embodiment, a maximum dimension of the drum core 10C along the first axis X is 3.2 mm. A maximum dimension of the drum core 10C along the second axis Y is 2.5 mm. A maximum dimension of the drum core 10C along the third axis Z is 2.3 mm.

The top plate 12 is a rectangular plate. The top plate 12 is shaped tabularly with the thickness direction extending along the third axis Z. The long sides of the top plate 12 extend parallel to the first axis X. The short sides of the top plate 12 extend parallel to the second axis Y. The top plate 12 is positioned away from the drum core 10C in the third negative direction Z2. The top plate 12 is connected to a surface of the first flange 20 facing in the third negative direction Z2 and also to a surface of the second flange 30 facing in the third negative direction Z2. In other words, the top plate 12 is suspended between the first flange 20 and the second flange 30. The top plate 12 is made of the same non-conductive material as that of the winding core 11.

The coil component 10 includes four outer electrodes 40. Two outer electrodes 40 are positioned on the end surface of the first flange 20 facing in the third positive direction Z1. The other two outer electrodes 40 are positioned on the end surface of the second flange 30 facing in the third positive direction Z1. In other words, the outer electrodes 40 are positioned on the surfaces of the first flange 20 and the second flange 30 that face in the same direction in which the first peripheral surface 11A faces. More specifically, one of the outer electrodes 40 is positioned on the first flange 20 in the second positive direction Y1 from the recess 21. Another one of the outer electrodes 40 is positioned on the first flange 20 in the second negative direction Y2 from the recess 21. One of the outer electrodes 40 is positioned on the second flange 30 in the second positive direction Y1 from the recess 31. Another one of the outer electrodes 40 is positioned on the second flange 30 in the second negative direction Y2 from the recess 31.

Each of the outer electrodes 40 includes a metallic layer and a plating layer. The metallic layer is made of silver. The metallic layer is formed on an outward-facing surface of the first flange 20 or of the second flange 30. The plating layer includes three sublayers. The plating layer is made of a copper layer, a nickel layer, and a tin layer that are laminated on the surface of the metallic layer in this order. FIG. 1 does not illustrate borderlines of the metallic layer and the plating layer. Note that the end surfaces of the coil component 10 facing in the third positive direction Z1 serve as mounting surfaces that oppose a circuit board when the coil component 10 is mounted.

First Wire and Second Wire

As illustrated in FIG. 1, the coil component 10 includes a first wire 51 and a second wire 52. The first wire 51 includes a copper wire and an insulating cover, of which the illustrations are omitted. The insulating cover covers the peripheral surface of the copper wire. A cross section of the first wire 51 taken in a direction orthogonal to the extending direction of the first wire 51 has a substantially circular shape. The diameter of the first wire 51 is 100 μm or more. More specifically, the diameter of the first wire 51 is about 140 μm. The second wire 52 has the same structure as that of the first wire 51. In other words, the second wire 52 includes the copper wire and the insulating cover. The diameter of the second wire 52 is about 140 μm. The first wire 51 is hatched with dots in FIG. 1.

The first wire 51 includes a first winding portion 51A and two first extended portions 51B.

As illustrated in FIGS. 2 to 5, the first winding portion 51A is a portion of the first wire 51 that is wound around the winding core 11 with the central axis C being the center of winding. The first winding portion 51A is in contact with the peripheral surfaces of the winding core 11. The first wire 51 is wound around the winding core 11 from the first flange 20 toward the second flange 30 in such a manner that the first wire 51 sequentially faces the first peripheral surface 11A, the second peripheral surface 11B, the third peripheral surface 11C, and the fourth peripheral surface 11D.

As illustrated in FIG. 3, a first end portion of the first winding portion 51A, which is the end near the first flange 20, is positioned on the borderline between the first peripheral surface 11A and the second peripheral surface 11B of the winding core 11. The first end portion of the first winding portion 51A is the portion at which the first wire 51 comes into first contact with a peripheral surface of the winding core 11 when the first wire 51 is traced from the end at the first flange 20 toward the second flange 30.

In the following description, the first end portion of the first winding portion 51A is the position of 0 turns of first winding portion 51A. Turns of the first winding portion 51A start from the first end portion toward the second flange 30. The number of turns increases by one every time the first winding portion 51A is wound around the winding core 11 with the central axis C being the center of winding. When the first winding portion 51A is viewed in the first negative direction X2, the first winding portion 51A is wound clockwise around the winding core 11 as the number of turns increases.

As illustrated in FIG. 2, the first wire 51 in the first winding portion 51A extends diagonally on the first peripheral surface 11A so as to come closer to the second flange 30 when the first winding portion 51A is traced from the first end portion. On the other hand, as illustrated in FIGS. 3 to 5, the first wire 51 in the first winding portion 51A extends in a direction orthogonal to the first axis X on the second peripheral surface 11B, on the third peripheral surface 11C, and also on the fourth peripheral surface 11D.

As illustrated in FIG. 5, a second end portion of the first winding portion 51A, which is the end near the second flange 30, is positioned on the borderline between the third peripheral surface 11C and the fourth peripheral surface 11D. As illustrated in FIG. 2, the second end portion of the first winding portion 51A is the portion at which the first wire 51 comes into first contact with a peripheral surface of the winding core 11 when the first wire 51 is traced from the end at the second flange 30 toward the first flange 20.

As illustrated in FIG. 2, one of the first extended portions 51B extends from the first end portion of the first winding portion 51A to an outer electrode 40 formed on the first flange 20, the outer electrode 40 being positioned on a side in the second negative direction Y2. The end portion of this first extended portion 51B is connected to the above outer electrode 40.

The other one of the first extended portions 51B extends from the second end portion of the first winding portion 51A to an outer electrode 40 formed on the second flange 30, the outer electrode 40 being positioned on a side in the second negative direction Y2. The end portion of this first extended portion 51B is connected to the above outer electrode 40.

The second wire 52 includes a second winding portion 52A and two second extended portions 52B.

The second winding portion 52A is a portion of the second wire 52 that is wound around the winding core 11 with the central axis C being the center of winding. The second winding portion 52A is in contact with the peripheral surfaces of the winding core 11 or with the first winding portion 51A. The second wire 52 is wound around the winding core 11 from the first flange 20 toward the second flange 30 in such a manner that the second wire 52 sequentially faces the first peripheral surface 11A, the second peripheral surface 11B, the third peripheral surface 11C, and the fourth peripheral surface 11D. In the present embodiment, the second wire 52 is wound around the winding core 11 from the first flange toward the second flange 30 in such a manner that the second wire 52 first faces the third peripheral surface 11C, then the fourth peripheral surface 11D, then the fourth peripheral surface 11A, and then the second peripheral surface 11B, starting from a first end portion of the second winding portion 52A. The above expression “sequentially faces the first peripheral surface 11A, the second peripheral surface 11B, the third peripheral surface 11C, and the fourth peripheral surface 11D” indicates the sequential order of winding and is not intended to specify the peripheral surface with which the winding starts. Accordingly, the above expression can encompass the case of the present embodiment in which the wire starts with a peripheral surface other than the first peripheral surface 11A.

As illustrated in FIG. 3, a first end portion of the second winding portion 52A, which is the end near the first flange 20, is positioned on the borderline between the second peripheral surface 11B and the third peripheral surface 11C of the winding core 11. The first end portion of the second winding portion 52A is the portion at which the second wire 52 comes into first contact with a peripheral surface of the winding core 11 when the second wire 52 is traced from the end at the first flange 20 toward the second flange 30.

As is the above-described case for the first wire 51, the first end portion of the second winding portion 52A is the position of 0 turns of second winding portion 52A. Turns of the second winding portion 52A start from the first end portion toward the second flange 30. The number of turns increases by one every time the second winding portion 52A is wound around the winding core 11 with the central axis C being the center of winding. When the second winding portion 52A is viewed in the first negative direction X2, the second winding portion 52A is wound clockwise around the winding core 11 as the number of turns increases.

As illustrated in FIG. 2, a second end portion of the second winding portion 52A, which is the end near the second flange 30, is positioned on the borderline between the first peripheral surface 11A and the fourth peripheral surface 11D. The second end portion of the second winding portion 52A is the portion at which the second wire 52 comes into first contact with a peripheral surface of the winding core 11 when the second wire 52 is traced from the end at the second flange 30 toward the first flange 20.

One of the second extended portions 52B extends from the first end portion of the second winding portion 52A to an outer electrode 40 formed on the first flange 20, the outer electrode 40 being positioned on a side in the second positive direction Y1. The end portion of this second extended portion 52B is connected to the above outer electrode 40.

The other one of the second extended portions 52B extends from the second end portion of the second winding portion 52A to an outer electrode 40 formed on the second flange 30, the outer electrode 40 being positioned on a side in the second positive direction Y1. The end portion of this second extended portion 52B is connected to the above outer electrode 40.

Assume that the second wire 52 is traced from the end at the first flange 20 toward the second flange 30. In this case, let a specific position SP be a position at which the second wire 52 comes into first contact with an outward-facing part of the first wire 51, which is the part of the first wire 51 positioned opposite to the winding core 11 as illustrated in FIG. 2. The specific position SP of the second winding portion 52A is positioned from 0.5 turns or more to less than one turn (i.e., from 0.5 turns to less than one turn) of second winding portion 52A. In the present embodiment, the specific position SP is positioned at about 0.75 turns of second winding portion 52A.

Let a specific turn ST be one turn portion of the second winding portion 52A from the specific position SP. In other words, the specific turn ST is located approximately from 0.75 turns of second winding portion 52A to less than 1.75 turns thereof. As illustrated in FIGS. 2 and 3, the second winding portion 52A has two intersections CP within the specific turn ST. The intersection CP is an intersection at which the second wire 52 intersects the first wire 51. In the present embodiment, the intersection CP is defined as a position at which the center line of the second wire 52 intersects the center line of the first wire 51 when the peripheral surface of the winding core 11 on which the second wire 52 intersects the first wire 51 is viewed in the direction normal to the peripheral surface.

When the second wire 52 is traced from the end at the first flange 20 toward the second flange 30, one of the two intersections CP that is closer to the first flange 20 is referred to as a first intersection CP1. In addition, when the second wire 52 is traced from the end at the first flange 20 toward the second flange 30, one of the two intersections CP that is closer to the second flange 30 is referred to as a second intersection CP2. The first intersection CP1 is positioned at the second peripheral surface 11B. When the second wire 52 is traced from the end at the first flange 20 toward the second flange 30, the first intersection CP1 is positioned within 0.5 turns from the specific position SP. The second intersection CP2 is positioned at the first peripheral surface 11A. The number of turns from the first intersection CP1 to the second intersection CP2 is 0.5 or more. More specifically, the number of turns from the first intersection CP1 to the second intersection CP2 is approximately 0.75. When the second wire 52 is traced from the end at the first flange 20 toward the second flange 30, the second intersection CP2 is positioned from more than 0.5 turns to one turn or less (i.e., from more than 0.5 turns to one turn) from the specific position SP.

Due to the second winding portion 52A having two intersections CP, the specific turn ST of the second winding portion 52A is spaced from the next turn that is the turn from about 1.75 turns or more to less than about the 2.75 turns (i.e., from about 1.75 turns to less than about the 2.75 turns) of second wire 52. In other words, the first wire 51 in the first winding portion 51A is exposed, in other words, not covered by the second wire 52, in the range of 1.75 turns or more to less than 2.75 turns (i.e., from 1.75 turns to less than 2.75 turns) of second winding portion 52A.

As illustrated in FIG. 2, the second wire 52 in the second winding portion 52A excluding the specific turn ST extends in a direction from the first flange 20 toward the second flange 30 on the first peripheral surface 11A when the second wire 52 is traced from the end at the first flange 20 toward the second flange 30. On the other hand, as illustrated in FIGS. 3 to 5, the second wire 52 in the second winding portion 52A extends in a direction orthogonal to the first axis X on the second peripheral surface 11B, on the third peripheral surface 11C, and also on the fourth peripheral surface 11D. An exception, however, is that in the second winding portion 52A, a portion of the second wire 52 that includes the first intersection CP1 extends in a direction from the second flange 30 toward the first flange 20 when the second wire 52 is traced from the end at the first flange 20 toward the second flange 30. More specifically, the second winding portion 52A includes a portion that extends in a direction from the second flange 30 toward the first flange 20, and the portion is positioned in an approximate range from 0.75 turns to one turn of the second winding portion 52A.

Note that the above expression “to extend in a direction from the first flange 20 toward the second flange 30” may encompass not only a case in which the wire extends in the direction parallel to the central axis C toward the second flange 30 but also a case in which the wire extends in a direction intersecting the central axis C obliquely toward the second flange 30. In other words, the expression “to extend in a direction from the first flange 20 toward the second flange 30” may encompass a case in which the extending direction of the wire has any component of the first negative direction X2 when the wire is traced from the end at the first flange 20 toward the second flange 30. The expression “to extend in a direction from the second flange 30 toward the first flange 20” should be interpreted in the same manner.

The turns of the second wire 52 are disposed along the central axis C at an equal pitch P on the borderline between the first peripheral surface 11A and the second peripheral surface 11B of the winding core 11. In the present embodiment, adjacent turns of the second wire 52 disposed along the central axis C are in contact with each other on the borderline between the first peripheral surface 11A and the second peripheral surface 11B of the winding core 11.

Method of Manufacturing Coil Component

A method of manufacturing the coil component 10 includes a preparation step, a first step, and a second step.

The preparation step is a step of preparing a drum core 10C equipped with the outer electrodes 40 as described below.

A drum core 10C is formed first in the preparation step. A synthetic resin binder is mixed with a ferrite powder. The mixture is subjected to press forming to produce a green compact, and the compact is sintered. The compact is then subjected to barrel polishing to remove burrs therefrom, thereby producing the drum core 10C. Next, a silver containing paste is applied to the surfaces of the first flange 20 and the second flange 30 of the drum core 10C, the surfaces facing in the third positive direction Z1, and the paste is subjected to baking. The outer electrodes 40 are formed by plating the baked paste with copper, nickel, and tin in this order.

Next, in the first step, the first end portion of the first wire 51 is attached to an outer electrode 40 on the first flange 20 using thermal pressure bonding, the outer electrode 40 being positioned on the side in the second negative direction Y2. The first wire 51 is wound around the winding core 11 from the first flange 20 toward the second flange 30. The first winding portion 51A is formed so as to be in contact with the peripheral surfaces of the winding core 11. Subsequently, the second end portion of the first wire 51 is attached to an outer electrode 40 on the second flange 30 using thermal pressure bonding, the outer electrode 40 being positioned on the side in the second negative direction Y2.

Next, in the second step, the first end portion of the second wire 52 is attached to an outer electrode 40 on the first flange 20 using thermal pressure bonding, the outer electrode 40 being positioned on the side in the second positive direction Y1. The second wire 52 is wound around the winding core 11 and on the outward-facing part of the first wire 51. The second winding portion 52A is formed so as to be in contact with the peripheral surfaces of the winding core 11 or with the first winding portion 51A. When the specific turn ST of the second wire 52 is wound around the winding core 11, the specific turn ST is wound in such a manner that the second wire 52 gradually come closer to the first flange 20 so as to cause the second wire 52 to intersect the first wire 51. The first intersection CP1 is thus formed. Subsequently, the second wire 52 is wound around the winding core 11 in such a manner that the second wire 52 gradually comes closer to the second flange 30 so as to cause the second wire 52 to intersect the first wire 51 again. The second intersection CP2 is thus formed. After the second winding portion 52A is formed, the second end portion of the second wire 52 is attached to an outer electrode 40 on the second flange 30 using thermal pressure bonding, the outer electrode 40 being positioned on the side in the second positive direction Y1.

Comparison With Known Example Where Second Wire Does Not Include Intersections

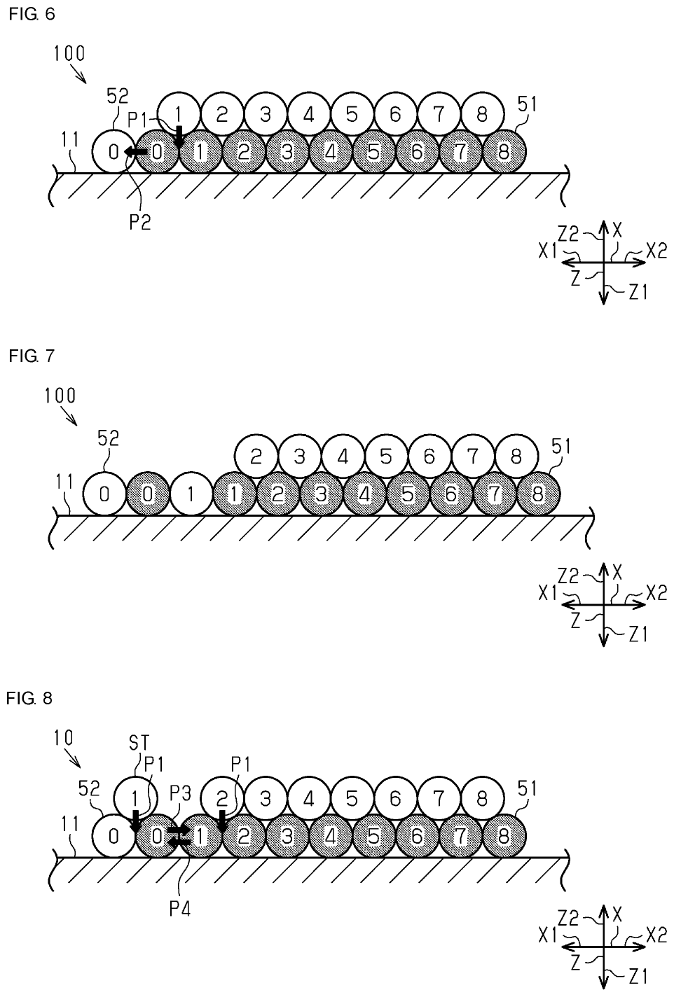

FIG. 6 illustrates a known coil component 100 in which the second wire 52 does not include the intersections CP and the second wire 52 extends constantly from the first flange 20 toward the second flange 30. In the example of FIG. 6, the first turn of the second wire 52 is wound over the outward-facing part of the first wire 51 at the position between the 0th turn and the first turn of the first wire 51. In addition, as illustrated in FIG. 6, the second turn and subsequent turns of the second wire 52 are wound over the outward-facing part of the first wire 51 so as to sequentially occupy positions between adjacent turns of the first wire 51.

When the second wire 52 is wound around the first wire 51, the second wire 52 is pressed against the first wire 51. As illustrated in FIG. 6, the second wire 52 is pressed in a direction of arrow P1 against the winding core 11. This causes the 0th turn of the first wire 51 to move in a direction of arrow P2.

As a result, as illustrated in FIG. 7, the second wire 52, which is supposed to stay on the outward-facing part of the first wire 51, may fall in between the 0th turn and the first turn of the first wire 51.

With regard to the coil component 10 of the above embodiment, the second wire 52 is also pressed against the first wire 51 when the second wire 52 is wound around the outward-facing part of the first wire 51. However, a portion of the second wire 52 between the first intersection CP1 and the second intersection CP2 in the specific turn ST is brought into contact with the side of the first wire 51 near the first flange 20. Meanwhile, a portion of the second wire 52 excluding the portion between the first intersection CP1 and the second intersection CP2 in the specific turn ST is brought into contact with the side of the first wire 51 near the second flange 30. In other words, a portion of the first wire 51 being in contact with the specific turn ST of the second wire 52 is pressed from both sides by the specific turn ST of the second wire 52.

More specifically, as illustrated in FIG. 8, the first turn of the second wire 52 is wound over the outward-facing part of the first wire 51 at a position between the 0th turn of the second wire 52 and the 0th turn of the first wire 51. Accordingly, when the first turn of the second wire 52 is wound over the outward-facing part of the first wire 51, the 0th turn of the first wire 51 is caused to move in a direction of arrow P3, in other words, move toward the first turn of the first wire 51.

The second turn of the second wire 52 is wound over the outward-facing part of the first wire 51 at a position between the first turn and the second turn of the first wire 51. Accordingly, when the second turn of the second wire 52 is wound over the outward-facing part of the first wire 51, the first turn of the first wire 51 is caused to move in a direction of arrow P4, in other words, move toward the 0th turn of the first wire 51.

The force that causes the 0th turn of the first wire 51 to move in the direction of arrow P3 acts oppositely to the force that causes the first turn of the first wire 51 to move in the direction of arrow P4. These two forces negate each other. As a result, the 0th turn and the first turn of the first wire 51 do not move easily when the first wire 51 receives the pressing forces from the second wire 52.

### Advantageous Effects of Present Embodiment

1) As described above, the portion of the first wire 51 being in contact with the specific turn ST of the second wire 52 is pressed by the second wire 52 from both sides along the central axis C. Accordingly, the portion of the first wire 51 being in contact with the specific turn ST of the second wire 52 does not move easily along the central axis C due to the pressing forces of the specific turn ST of the second wire 52. Since the portion of the first wire 51 being in contact with the specific turn ST of the second wire 52 does not move easily, the other portion of the first wire 51 does not move easily. Accordingly, the second wire 52 wound around the first wire 51 does not move easily, either. This increases the likelihood of each wire being wound around as specified in design.

2) The second wire 52 are wound such that adjacent turns are in close contact with each other in the vicinity of the center of the second winding portion 52A along the central axis C. Accordingly, the second wire 52 does not move easily along the central axis C in the vicinity of the center of the second winding portion 52A compared with the vicinity of the first end portion of the second winding portion 52A. In other words, in the vicinity of the first end portion of the second winding portion 52A, the second wire 52 is more likely to move along the central axis C due to, for example, the second wire 52 falling off from the first wire 51. According to the above embodiment, however, the specific position SP is positioned from 0.5 turns or more to less than one turn (i.e., from 0.5 turns to less than one turn) of second winding portion 52A. In other words, the two intersections CP occur relatively in a small-number turn of the second winding portion 52A. Accordingly, the advantageous effect described in 1) above can be obtained where the second wire 52 in the second winding portion 52A tends to fall off from the first wire 51.

3) According to the above embodiment, the first intersection CP1 is positioned at the second peripheral surface 11B of the winding core 11. Since the first intersection CP1 is positioned at one of the peripheral surfaces of the winding core 11, the first intersection CP1 is prevented from moving easily compared with a case where the first intersection CP1 is positioned at a borderline between adjacent peripheral surfaces.

4) According to the above embodiment, the second intersection CP2 is positioned at the first peripheral surface 11A of the winding core 11. Since the second intersection CP2 is positioned at one of the peripheral surfaces of the winding core 11, the second intersection CP2 is prevented from moving easily compared with a case where the second intersection CP2 is positioned at a borderline between adjacent peripheral surfaces.

5) The second wire 52 intersects the first wire 51 at the first intersection CP1 and the second intersection CP2, and each intersection CP may be displaced when the second wire 52 is wound around. Especially in the case where the first intersection CP1 and the second intersection CP2 are too close to each other, the likelihood of each intersection CP being displaced increases.

According to the above embodiment, however, the first intersection CP1 is positioned at the second peripheral surface 11B of the winding core 11, and the second intersection CP2 is positioned at the first peripheral surface 11A of the winding core 11. In other words, when the second wire 52 is traced from the end at the first flange 20 toward the second flange 30, the distance between the first intersection CP1 and the second intersection CP2 is 0.5 turns or more. With this configuration, the first intersection CP1 and the second intersection CP2 are not displaced easily compared with the case where the distance between the first intersection CP1 and the second intersection CP2 is less than 0.5 turns.

6) In the above embodiment, the outer electrodes 40 are positioned on the surfaces of the first flange 20 and the second flange 30 that face in the same direction in which the first peripheral surface 11A faces. In addition, in the present embodiment, the first intersection CP1 is positioned at the second peripheral surface 11B of the winding core 11. Accordingly, the first end portion of the second winding portion 52A is pressed by a portion of the second wire 52 wound after the intersection. This reduces the likelihood of the second winding portion 52A being detached from the winding core 11.

7) According to the above embodiment, the turns of the second wire 52 are disposed along the central axis C at an equal pitch P on the borderline between the first peripheral surface 11A and the second peripheral surface 11B. This prevents the disorderly winding of the second wire 52 from occurring easily when the second wire 52 is wound around the winding core 11 and the outward-facing part of the first wire 51.

8) In the above embodiment, the first intersection CP1 is positioned within 0.5 turns from the specific position SP when the second wire 52 is traced from the end at the first flange 20 toward the second flange 30. Similarly, the second intersection CP2 is positioned from more than 0.5 turns to one turn or less (i.e., from more than 0.5 turns to one turn) from the specific position SP. In other words, the first intersection CP1 occurs in a first half portion of the specific turn ST, and the second intersection CP2 occurs in a second half portion of the specific turn ST. In other words, both intersections CP are not present concentratedly in a narrow portion of the specific turn ST. Accordingly, the first intersection CP1 and the second intersection CP2 are not displaced easily.

9) In the above embodiment, a portion of the second winding portion 52A excluding the specific turn ST extends in a direction from the first flange 20 toward the second flange or in the direction orthogonal to the central axis C when the second winding portion 52A is traced from the first end portion. On the other hand, a portion of the second winding portion 52A including the first intersection CP1 extends in a direction from the second flange 30 toward the first flange 20 when the second winding portion 52A is traced from the first end portion. In other words, in the second winding portion 52A, the portion including the first intersection CP1 is wound in a direction different from the winding direction of the portion excluding the specific turn ST. Accordingly, two intersections CP can be formed easily by changing the winding direction.

10) According to the above embodiment, the method of manufacturing the coil component 10 includes the first step in which the first wire 51 is wound around the winding core 11 and the second step in which the second wire 52 is wound around after the first step. With this method, the two intersections CP can be formed easily in the second winding portion 52A compared with a manufacturing method in which the first wire 51 and the second wire 52 are wound simultaneously.

11) The greater the diameter of the second wire 52, the greater the force required to wind the second wire 52. Accordingly, when the second wire 52 is wound around, the force of pressing the second wire 52 against the first wire 51 increases. Accordingly, the greater the diameter of the second wire 52, the higher the likelihood of the first wire 51 moving along the central axis C. In the above embodiment, the diameter of the second wire 52 is about 140 μm. The technique described in the above embodiment can be preferably applied to the wire having such a diameter.

### Modification Examples

The present embodiment can be implemented in modified manners as described below. The present embodiment and modifications below can be combined with one another insofar as the combination does not pose any technical contradiction.

The structure of the coil component 10 is not limited to what has been described in the above embodiment. For example, the coil component 10 does not need to have the top plate 12. In addition, the shape of the first flange 20 is not limited to what has been described in the above embodiment. For example, the first flange 20 does not need to have the recess 21.

In the above embodiment, the winding core 11 does not need to be the quadrangular prism. For example, the cross section of the winding core 11 can be shaped like a circle, an oval, or a polygon other than a rectangle. In other words, the winding core 11 does not need to have the first to fourth peripheral surfaces 11A to 11D.

In the above embodiment, the ridges of the winding core 11 can be chamfered. In other words, the borderlines of the peripheral surfaces can include round surfaces formed by rounding the edges between adjacent peripheral surfaces.

The shape and the dimensions of the drum core 10C are not limited to what has been described in the above embodiment.

The material of the outer electrodes 40 is not limited to what has been described in the above embodiment. For example, the plating material of the outer electrodes 40 can be nickel alloy. The outer electrodes 40 does not need to include the plating layer, and the electrically conductive metallic layer can be exposed. The outer electrodes 40 can be tabular metallic terminals.

The diameter of the first wire 51 and the second wire 52 is not limited to the examples described in the above embodiment.

The position of the specific position SP is not limited to what has been described in the above embodiment. For example, the specific position SP can be positioned less than 0.5 turns of the second winding portion 52A or can be positioned one turn or more of the second winding portion 52A.

In the above embodiment, the position of 0 turns of the second winding portion 52A does not need to be positioned on the borderline between the first peripheral surface 11A and the second peripheral surface 11B. For example, the position of 0 turns of the second winding portion 52A can be positioned at the second peripheral surface 11B or on a borderline of adjacent peripheral surfaces other than what has been described in the above embodiment.

In the above embodiment, the first winding portion 51A can be wound around the winding core 11 or around the second wire 52. This also applies to the second winding portion 52A. In other words, the second winding portion 52A can be wound around the winding core 11 or around the first wire 51.

The positions of the first intersection CP1 and the second intersection CP2 are not limited to what has been described in the above embodiment. In other words, the first intersection CP1 does not need to be positioned at the second peripheral surface 11B of the winding core 11. Moreover, the second intersection CP2 does not need to be positioned at the first peripheral surface 11A of the winding core 11. The positions of the intersections CP can be adjusted, and accordingly the distance between the first intersection CP1 and the second intersection CP2 can be less than 0.5 turns.

In the above embodiment, the first intersection CP1 can be positioned from more than 0.5 turns to one turn or less (i.e., from more than 0.5 turns to one turn) from the specific position SP when the second wire 52 is traced from the first flange 20 toward the second flange 30. The second intersection CP2 can be positioned 0.5 turns or less from the specific position SP.

In the above embodiment, the turns of the second wire 52 do not need to be disposed along the central axis C at an equal pitch P on the borderline between the first peripheral surface 11A and the second peripheral surface 11B. The turns of the second wire 52 can have different pitches P at different positions along the central axis C. Note that the advantageous effect described in 1) above can be obtained in the coil component 10 even if the turns of the second wire 52 are disposed along the central axis C at different pitches P. The turns of the first wire 51 can be positioned respectively between adjacent turns of the second wire 52 along the central axis C.

In the above embodiment, the portion of the second winding portion 52A that includes the first intersection CP1 can extend in a direction from the first flange 20 toward the second flange 30. In other words, the second wire 52 can cross the first wire 51 from the side near the first flange 20 to the other side near the second flange 30 at the first intersection CP1.

In the above embodiment, the first step and the second step can be carried out simultaneously.

The method of manufacturing the drum core 10C in the preparation step is not limited to what has been described in the above embodiment. For example, the drum core 10C can be obtained by grinding a cubic core of ferrite.

Technical ideas derived from the above embodiment and the modifications are listed as follows.

[1] A coil component includes i) a drum core including a winding core shaped like a column or prism, a first flange connected to a first end portion of the winding core, the first end portion being positioned along a central axis of the winding core, and a second flange connected to a second end portion of the winding core, the second end portion being positioned oppositely to the first end portion along the central axis. The coil component also includes ii) a first wire wound around the winding core, and iii) a second wire wound around the winding core. In the coil component, the first wire includes a first winding portion wound around with the central axis being a center of winding, and the second wire includes a second winding portion wound around with the central axis being the center of winding. In addition, when i) a specific position is a position at which the second wire comes into first contact with an outward-facing part of the first wire, the part facing oppositely to the winding core, when the second wire is traced from an end thereof at the first flange toward the second flange and ii) a specific turn is a turn of the second wire that is wound around from the specific position so as to proceed toward the second flange, the second winding portion has two intersections at which the second wire intersects the first wire within the specific turn.

[2] In the coil component described in [1] above, when i) a position of 0 turns of the second winding portion is defined as a position at which the second wire comes into first contact with a peripheral surface of the winding core when the second wire is traced from the end thereof at the first flange so as to proceed toward the second flange and ii) the number of turns increases by one every time the second wire is wound around with the central axis being the center of winding so as to proceed toward the second flange, the specific position is positioned from 0.5 turns or more to less than one turn (i.e., from 0.5 turns to less than one turn) of the second winding portion.

[3] In the coil component described in [1] or [2] above, the winding core has a quadrilateral cross section that extends in directions orthogonal to the central axis. The winding core has a first peripheral surface, a second peripheral surface adjoining the first peripheral surface, a third peripheral surface adjoining the second peripheral surface and extending parallel to the first peripheral surface, a fourth peripheral surface adjoining the third peripheral surface and the first peripheral surface and extending parallel to the second peripheral surface. When a position of 0 turns of the second winding portion is defined as a position at which the second wire comes into first contact with a peripheral surface of the winding core when the second wire is traced from the end thereof at the first flange toward the second flange, the position of 0 turns of the second winding portion is positioned on a borderline between the second peripheral surface and the third peripheral surface. The second wire is wound around so as to proceed from the first flange toward the second flange in such a manner that the second wire sequentially faces the first peripheral surface, the second peripheral surface, the third peripheral surface, and the fourth peripheral surface. When a first intersection is defined as one of the two intersections that is closer to the first flange when the second wire is traced from the first flange toward the second flange, the first intersection is positioned at the second peripheral surface.

[4] In the coil component described in [3] above, when i) a position of 0 turns of the second winding portion is defined as a position at which the second wire comes into first contact with a peripheral surface of the winding core when the second wire is traced from the end thereof at the first flange toward the second flange and ii) the number of turns increases by one every time the second wire is wound around with the central axis being the center of winding so as to proceed toward the second flange, the specific position is positioned from 0.5 turns or more to less than one turn (i.e., from 0.5 turns to less than one turn) of the second winding portion. The coil component further includes outer electrodes to which end portions of the first wire and end portions of the second wire are connected, and the outer electrodes are positioned on surfaces of the first flange and the second flange, the surfaces facing in a direction in which the first peripheral surface faces.

[5] In the coil component described in [1] to [4] above, the winding core has a quadrilateral cross section that extends in directions orthogonal to the central axis. The winding core has a first peripheral surface, a second peripheral surface adjoining the first peripheral surface, a third peripheral surface adjoining the second peripheral surface and extending parallel to the first peripheral surface, and a fourth peripheral surface adjoining the third peripheral surface and the first peripheral surface and extending parallel to the second peripheral surface. When a position of 0 turns of the second winding portion is defined as a position at which the second wire comes into first contact with a peripheral surface of the winding core when the second wire is traced from the end thereof at the first flange toward the second flange, the position of 0 turns of the second winding portion is positioned on a borderline between the second peripheral surface and the third peripheral surface. When a second intersection is defined as one of the two intersections that is closer to the second flange when the second wire is traced from the first flange toward the second flange, the second intersection is positioned at the first peripheral surface.

[6] In the coil component described in [1] to [5] above, the winding core has a quadrilateral cross section that extends in directions orthogonal to the central axis. The winding core has a first peripheral surface, a second peripheral surface adjoining the first peripheral surface, a third peripheral surface adjoining the second peripheral surface and extending parallel to the first peripheral surface, and a fourth peripheral surface adjoining the third peripheral surface and the first peripheral surface and extending parallel to the second peripheral surface. When a position of 0 turns of the second winding portion is defined as a position at which the second wire comes into first contact with a peripheral surface of the winding core when the second wire is traced from the end thereof at the first flange toward the second flange, the position of 0 turns of the second winding portion is positioned on a borderline between the second peripheral surface and the third peripheral surface. When a first intersection is defined as one of the two intersections that is closer to the first flange and a second intersection is defined as the other one of the two intersections that is closer to the second flange when the second wire is traced from the first flange toward the second flange, the first intersection is positioned at the second peripheral surface and the second intersection is positioned at the first peripheral surface.

[7] In the coil component described in [3] to [6] above, turns of the second wire are disposed along the central axis at an equal pitch on a borderline between the first peripheral surface and the second peripheral surface.

[8] In the coil component described in [1] to [7] above, when a first intersection is one of the two intersections that is closer to the first flange and a second intersection is the other one of the two intersections that is closer to the second flange when the second wire is traced from the first flange toward the second flange, a distance between the first intersection and the second intersection is 0.5 turns or more.

[9] In the coil component described in [1] to [8] above, when a first intersection is one of the two intersections that is closer to the first flange when the second wire is traced from the first flange toward the second flange, the first intersection is positioned 0.5 turns or less from the specific position.

[10] In the coil component described in [1] to [9] above, when a second intersection is one of the two intersections that is closer to the second flange when the second wire is traced from the first flange toward the second flange, the second intersection is positioned from more than 0.5 turns to one turn or less (i.e., from more than 0.5 turns to one turn) from the specific position.

[11] In the coil component described in [1] to above, when a first intersection is one of the two intersections that is closer to the first flange and a second intersection is the other one of the two intersections that is closer to the second flange when the second wire is traced from the first flange toward the second flange, the first intersection is positioned 0.5 turns or less from the specific position and the second intersection is positioned from more than 0.5 turns to one turn or less (i.e., from more than 0.5 turns to one turn) from the specific position.

[12] In the coil component described in [1] to above, when a first intersection is one of the two intersections that is closer to the first flange when the second wire is traced from the first flange toward the second flange, a portion of the second winding portion that excludes the specific turn extends in a direction orthogonal to the central axis or extends so as to proceed from the first flange toward the second flange when the second wire is traced from the first flange toward the second flange. A portion of the second winding portion that includes the first intersection extends so as to proceed from the second flange toward the first flange.

[13] A method of manufacturing a coil component includes i) a first step of winding a first wire around a drum core, the drum core including a winding core shaped like a column or prism, a first flange connected to a first end portion of the winding core, the first end portion being positioned along a central axis of the winding core, and a second flange connected to a second end portion of the winding core, the second end portion being positioned oppositely to the first end portion along the central axis, and ii) a second step of winding a second wire around the drum core. In the first step, a first winding portion is formed by winding the first wire around the winding core from the first flange with the central axis being a center of winding. In the second step, a second winding portion is formed by winding the second wire around the winding core from the first flange with the central axis being the center of winding. When i) a specific position is a position at which the second wire comes into first contact with an outward-facing part of the first wire, the part facing oppositely to the winding core, when the second wire is traced from an end thereof at the first flange toward the second flange and ii) a specific turn is a turn of the second wire that is wound around from the specific position so as to proceed toward the second flange, the second wire is wound, in the second step, in such a manner that the second wire intersects the first wire twice within the specific turn.

What is claimed is:

1. A coil component comprising:
a drum core including
a prism shaped winding core,
a first flange connected to a first end portion of the winding core, the first end portion being positioned along a central axis of the winding core, and
a second flange connected to a second end portion of the winding core, the second end portion being positioned opposite to the first end portion along the central axis;
a first wire wound around the winding core; and
a second wire wound around the winding core,
wherein
the first wire includes a first winding portion wound around with the central axis being a center of winding,
the second wire includes a second winding portion wound around with the central axis being the center of winding, and
when i) a specific position is a position at which the second wire is in first contact with an outward-facing part of the first wire, the part being positioned opposite to the winding core, when the second wire is traced from an end of the second wire at the first flange toward the second flange and ii) a specific turn is a turn of the second wire that is wound around from the specific position so as to proceed toward the second flange, the second winding portion includes two intersections at which the second wire intersects the first wire within a range of the specific turn.

2. The coil component according to claim 1, wherein
when i) a position of 0 turns of the second winding portion is defined as a position at which the second wire is in first contact with a peripheral surface of the winding core when the second wire is traced from the end of the second wire at the first flange so as to proceed toward the second flange and ii) a number of turns increases by every one time the second wire is wound around about the central axis being the center of winding so as to proceed toward the second flange, the specific position is positioned in a range from 0.5 turns to less than 1 turn of the second winding portion.

3. The coil component according to claim 1, wherein
the winding core has
a quadrilateral cross section that extends in directions orthogonal to the central axis,
a first peripheral surface,
a second peripheral surface adjoining the first peripheral surface,
a third peripheral surface adjoining the second peripheral surface and extending parallel to the first peripheral surface, and
a fourth peripheral surface adjoining the third peripheral surface and the first peripheral surface and extending parallel to the second peripheral surface,
when a position of 0 turns of the second winding portion is defined as a position at which the second wire is in first contact with a peripheral surface of the winding core when the second wire is traced from the end of the second wire at the first flange toward the second flange, the position of 0 turns of the second winding portion is positioned on a borderline between the second peripheral surface and the third peripheral surface,
the second wire is wound around so as to proceed from the first flange toward the second flange in such a manner that the second wire sequentially faces the first peripheral surface, the second peripheral surface, the third peripheral surface, and the fourth peripheral surface, and
when a first intersection is defined as one of the two intersections that is closer to the first flange when the second wire is traced from the first flange toward the second flange, the first intersection is positioned at the second peripheral surface.

4. The coil component according to claim 3, wherein
when i) a position of 0 turns of the second winding portion is defined as a position at which the second wire is in first contact with a peripheral surface of the winding core when the second wire is traced from the end of the second wire at the first flange toward the second flange and ii) a number of turns increases by every one time the second wire is wound around about the central axis being the center of winding so as to proceed toward the second flange, the specific position is positioned in a range from 0.5 turns to less than 1 turn of the second winding portion,
the coil component further comprising outer electrodes to which end portions of the first wire and end portions of the second wire are connected, and
the outer electrodes are positioned on surfaces of the first flange and the second flange, the surfaces facing in a direction in which the first peripheral surface faces.

5. The coil component according to claim 1, wherein
the winding core has
a quadrilateral cross section that extends in directions orthogonal to the central axis,
a first peripheral surface,
a second peripheral surface adjoining the first peripheral surface,
a third peripheral surface adjoining the second peripheral surface and extending parallel to the first peripheral surface, and
a fourth peripheral surface adjoining the third peripheral surface and the first peripheral surface and extending parallel to the second peripheral surface,
when a position of 0 turns of the second winding portion is defined as a position at which the second wire is in first contact with a peripheral surface of the winding core when the second wire is traced from the end of the second wire at the first flange toward the second flange, the position of 0 turns of the second winding portion is positioned on a borderline between the second peripheral surface and the third peripheral surface, and
when a second intersection is defined as one of the two intersections that is closer to the second flange when the second wire is traced from the first flange toward the second flange, the second intersection is positioned at the first peripheral surface.

6. The coil component according to claim 1, wherein
the winding core has
a quadrilateral cross section that extends in directions orthogonal to the central axis,
a first peripheral surface,
a second peripheral surface adjoining the first peripheral surface,
a third peripheral surface adjoining the second peripheral surface and extending parallel to the first peripheral surface, and
a fourth peripheral surface adjoining the third peripheral surface and the first peripheral surface and extending parallel to the second peripheral surface,
when a position of 0 turns of the second winding portion is defined as a position at which the second wire is in first contact with a peripheral surface of the winding core when the second wire is traced from the end of the second wire at the first flange toward the second flange, the position of 0 turns of the second winding portion is positioned on a borderline between the second peripheral surface and the third peripheral surface, and
when a first intersection is defined as one of the two intersections that is closer to the first flange and a second intersection is defined as the other one of the two intersections that is closer to the second flange when the second wire is traced from the first flange toward the second flange, the first intersection is positioned at the second peripheral surface and the second intersection is positioned at the first peripheral surface.

7. The coil component according to claim 3, wherein
turns of the second wire are disposed at an equal pitch in a direction along the central axis on a borderline between the first peripheral surface and the second peripheral surface.

8. The coil component according to claim 1, wherein
when a first intersection is one of the two intersections that is closer to the first flange and a second intersection is the other one of the two intersections that is closer to the second flange when the second wire is traced from the first flange toward the second flange, a number of turns between the first intersection and the second intersection is 0.5 turns or more.

9. The coil component according to claim 1, wherein
when a first intersection is one of the two intersections that is closer to the first flange when the second wire is traced from the first flange toward the second flange, the first intersection is positioned 0.5 turns or less from the specific position.

10. The coil component according to claim 1, wherein
when a second intersection is one of the two intersections that is closer to the second flange when the second wire is traced from the first flange toward the second flange, the second intersection is positioned from more than 0.5 turns to 1 turn from the specific position.

11. The coil component according to claim 1,
wherein when a first intersection is one of the two intersections that is closer to the first flange and a second intersection is the other one of the two intersections that is closer to the second flange when the second wire is traced from the first flange toward the second flange, the first intersection is positioned 0.5 turns or less from the specific position and the second intersection is positioned from more than 0.5 turns to 1 turn from the specific position.

12. The coil component according to claim 1,
wherein when a first intersection is one of the two intersections that is closer to the first flange when the second wire is traced from the first flange toward the second flange, a portion of the second winding portion except for the specific turn extends in a direction orthogonal to the central axis or extends so as to proceed from the first flange toward the second flange when the second wire is traced from the first flange toward the second flange, and
wherein a portion of the second winding portion that includes the first intersection extends so as to proceed from the second flange toward the first flange.

13. The coil component according to claim 4, wherein
turns of the second wire are disposed at an equal pitch in a direction along the central axis on a borderline between the first peripheral surface and the second peripheral surface.

14. The coil component according to claim 5, wherein
turns of the second wire are disposed at an equal pitch in a direction along the central axis on a borderline between the first peripheral surface and the second peripheral surface.

15. The coil component according to claim 6, wherein
turns of the second wire are disposed at an equal pitch in a direction along the central axis on a borderline between the first peripheral surface and the second peripheral surface.

16. A method of manufacturing a coil component, the method comprising:
a first step of winding a first wire around a drum core, the drum core including
a prism shaped winding core,
a first flange connected to a first end portion of the winding core, the first end portion being positioned along a central axis of the winding core, and
a second flange connected to a second end portion of the winding core, the second end portion being positioned opposite to the first end portion along the central axis; and
a second step of winding a second wire around the drum core,
wherein in the first step, a first winding portion is formed by winding the first wire around the winding core from the first flange about the central axis being a center of winding,
wherein in the second step, a second winding portion is formed by winding the second wire around the winding core from the first flange about the central axis being the center of winding, and
wherein when i) a specific position is a position at which the second wire is in first contact with an outward-facing part of the first wire, the part being positioned opposite to the winding core, when the second wire is traced from an end of the second wire at the first flange toward the second flange and ii) a specific turn is a turn of the second wire that is wound around from the specific position so as to proceed toward the second flange, the second wire is wound, in the second step, in such a manner that the second wire intersects the first wire twice within a range of the specific turn.
